(19) United States
(12) Patent Application Publication
(10) Pub. No.: US 2016/0316065 A1
(43) Pub. Date: Oct. 27, 2016

(54) APPARATUS AND METHOD OF PROVIDING CALL CONNECTION INFORMATION

(71) Applicant: NAVER CORPORATION, Seongnam-si (KR)

(72) Inventors: Hyeon Su Jeong, Seongnam-si (KR); Dong Ki Kim, Seongnam-si (KR); Eun Mi Kim, Seongnam-si (KR); Hyeon Sik Moon, Seongnam-si (KR)

(21) Appl. No.: 15/136,014

(22) Filed: Apr. 22, 2016

(30) Foreign Application Priority Data
Apr. 23, 2015 (KR) 10-2015-0057286

(51) Int. Cl. H04M 7/00; G06F 3/0481; G06F 3/0484

(52) U.S. Cl. CPC H04M 7/003; G06F 3/04842; G06F 3/0481; H04M 2203/551

(57) ABSTRACT

Provided are an apparatus and method of providing call connection information. The apparatus includes: a receiver configured to receive a phone number link object signal enabling a call connection with a third terminal selected by a user from a webpage on a first terminal, which is authenticated by using access identification (ID) information; a searcher configured to search for a second terminal that is authenticated by using the access ID information and activated by using an application corresponding to the webpage; and a call connection information provider configured to generate call connection information including a phone number link object and provide the call connection information to the second terminal found by the searcher.

### CROSS-REFERENCE TO RELATED APPLICATION

This application claims the benefit of Korean Patent Application No. 10-2015-0057286, filed on Apr. 23, 2015, in the Korean Intellectual Property Office, the disclosure of which is incorporated herein in its entirety by reference.

### BACKGROUND

1. Field

One or more embodiments of the present invention relate to an apparatus and method of providing call connection information.

2. Description of the Related Art

Today, information searches using communication networks have been generalized together with rapid development of the communication network, such as the Internet. In other words, internet users easily obtain necessary information anywhere at any time by using the Internet and such information searches have brought many changes to people's lives in general. The Internet is used as a popular communication method that transcends national borders according to development of communication and computers, and the number of users using the Internet is gradually increasing. In this regard, the number of services targeting internet users is gradually increasing.

A search service using the Internet is a service that searches for data matching a keyword by using a search engine. As the search engine is upgraded and elaborated, a search algorithm that exposes a webpage providing credible information or practical information at the top of a search result is under development.

Information disclosed in this Background section was already known to the inventors before achieving the disclosure the present invention or is technical information acquired in the process of achieving the disclosure. Therefore, it may contain information that does not form the prior art that is already known to the public in this country.

### SUMMARY

One or more embodiments of the present invention include an apparatus and a method of providing information, in which, when a webpage and an application corresponding to the webpage are both authenticated on different terminals or the same terminal, a phone number link object selected by a user from the webpage is pushed to the application to enable a call connection with the phone number link object on the different terminals or the same terminal.

One or more embodiments include an apparatus and a method of providing information, in which, when a webpage and an application corresponding to the webpage are both authenticated on different terminals or the same terminal, a phone number link object included in detail information related to information selected by a user from the webpage is pushed to the application to enable a call connection with the phone number link object on the different terminals or the same terminal.

One or more embodiments include an apparatus and a method of providing information, in which, during a call connection with a phone number link object on a terminal, a callee is notified about a route through which a caller obtained a phone number of the callee.

Additional aspects will be set forth in part in the description which follows and, in part, will be apparent from the description.

According to one or more embodiments, an apparatus for providing call connection information includes: a receiver configured to receive a phone number link object signal enabling a call connection with a third terminal that is an advertiser terminal selected by a user from a webpage on a first terminal, which is authenticated by using access identification (ID) information; a searcher configured to search for a second terminal that is authenticated by using the access ID information and activated by using an application corresponding to the webpage; and a call connection information provider configured to generate call connection information including a phone number link object and provide the call connection information to the second terminal found by the searcher.

The receiver may be further configured to receive a selection signal of the phone number link object included in detail information related to information selected by the user from the webpage of the first terminal.

When the second terminal is not found by the searcher, the call connection information provider may search for history information of the application and provide the call connection information to a terminal having the history information.

When the second terminal is not found by the searcher, the call connection information provider may provide the call connection information to a terminal number that is authenticated.

The apparatus may further include a message provider configured to provide a first message indicating that the call connection information is transmitted to the second terminal to the webpage of the first terminal.

The apparatus may further include a calling route information provider configured to compare first call information related to the first and second terminals according to a selection signal of the phone number link object displayed on the webpage of the first terminal and second call information related to a call signal from the third terminal driven according to the selection signal, and display some of the first call information on the third terminal according to a matching determination result of the selection signal and the call signal.

The first and second terminals may be the same terminal.

According to one or more embodiments, a method of providing call connection information includes: receiving, by a receiver, a phone number link object signal enabling a call connection with a third terminal that is an advertiser terminal selected by a user from a webpage on a first terminal, which is authenticated by using access identification (ID) information; searching for, by a searcher, a second terminal that is authenticated by using the access ID information and activated by using an application corresponding to the webpage; and generating and providing, by a call connection information provider, call connection information including a phone number link object to the second terminal found by the searcher.

The receiving may include receiving a selection signal of the phone number link object included in detail information related to information selected by the user from the webpage of the first terminal.

When the second terminal is not found by the searcher, the generating and providing may include searching for history information of the application and providing the call connection information to a terminal having the history information.

When the second terminal is not found by the searcher, the generating and providing may include providing the call connection information to a terminal number that is authenticated.

The method may further include providing, by a message provider, a first message indicating that the call connection information is transmitted to the second terminal to the webpage of the first terminal.

The method may further include comparing, by a calling route information provider, first call information related to the first and second terminals according to a selection signal of the phone number link object displayed on the webpage of the first terminal and second call information related to a call signal from the third terminal driven according to the selection signal, and displaying, by the calling route information provider, some of the first call information on the third terminal according to a matching determination result of the selection signal and the call signal.

The first and second terminals may be the same terminal.

According to one or more embodiments, a non-transitory computer-readable recording medium has recorded thereon a program, which when executed by a computer, performs the method of providing call connection information described above.

### BRIEF DESCRIPTION OF THE DRAWINGS

These and/or other aspects will become apparent and more readily appreciated from the following description of the embodiments, taken in conjunction with the accompanying drawings in which:

FIG. 1 is a drawing for schematically describing a system for providing information, according to an embodiment;

FIG. 2 is a block diagram of a detailed structure of an apparatus for providing information, which is included in the system of FIG. 1, according to an embodiment;

FIG. 3 is a block diagram of a detailed structure of a calling route information provider included in the apparatus of FIG. 2, according to an embodiment;

FIG. 4 is a block diagram of a detailed structure of a first terminal included in the system of FIG. 1, according to an embodiment;

FIG. 5 is a block diagram of a detailed structure of a second terminal included in the system of FIG. 1, according to an embodiment;

FIG. 6 is a block diagram of a detailed structure of a third terminal included in the system of FIG. 1, according to an embodiment;

FIGS. 7A-7D, 8A-8B, 9A-9E, 10A-10E illustrate examples of information-related screens provided by an apparatus for providing information, according to embodiments; and

FIG. 11 is a flowchart of a method of providing information, according to an embodiment.

### DETAILED DESCRIPTION

Advantages and features of one or more embodiments and methods of accomplishing the same may be understood more readily by reference to the following detailed description of the embodiments and the accompanying drawings. In this regard, the embodiments may have different forms and should not be construed as being limited to the descriptions set forth herein. Rather, these embodiments are provided so that this disclosure will be thorough and complete and will fully convey the concept of the embodiments to one of ordinary skill in the art, and the disclosure will only be defined by the appended claims. In the description of the embodiments, certain detailed explanations of related art are omitted when it is deemed that they may unnecessarily obscure the essence of the disclosure.

The terms used in the present specification are merely used to describe particular embodiments, and are not intended to limit the disclosure. An expression used in the singular encompasses the expression in the plural, unless it has a clearly different meaning in the context. In the present specification, it is to be understood that terms such as “including” or “having”, etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. While such terms as “first”, “second”, etc., may be used to describe various components, such components must not be limited to the above terms. The above terms are used only to distinguish one component from another.

As used herein, the term “and/or” includes any and all combinations of one or more of the associated listed items. Expressions such as at least one of,” when preceding a list of elements, modify the entire list of elements and do not modify the individual elements of the list.

Herein, a “webpage” denotes web content on the Internet, and the web content may include various texts, images, sound, and video files. According to an embodiment, a webpage may include web content indicating a search result of searching for data matching a keyword or a search word input by a user by using a search service provided by a search portal. A webpage showing the search result using the search service provided by the search portal may display news information, website information, blog information, image information, café information, map information, content information (a video, music, a document, a magazine, a book, etc.), opencast information, shopping information, and advertisement information, which include the keyword or the search word. Also, a contact number (phone number) of a publisher (a second user described later) who posted such information may be displayed on the webpage.

Herein, an “application” may include an application program executable on a mobile terminal, for example, a user terminal, such as a smart phone. Also, such an application may be purchased or downloaded for free through a website professionally setting applications on a user terminal or the Internet, such as an App Store, Market, or T Store. A basic function of an application is to provide convenience in real life, provide information in real-time, and help a user to use a mobile terminal. Functions of an application vary according to the type of an application, and the user needs to download an application having a function desired by the user. Hundreds of thousands of applications having various purposes, such as social networking, maps, education, games, and music, have been developed and sold. According to an embodiment, an application may include an application executable on a mobile terminal in the same format as a search portal.

For example, when a search portal is Naver, Daum, or Yahoo, a webpage may include news information, website information, blog information, image information, café information, map information, content information, opencast information, shopping information, and shopping information including a keyword or a search word provided by Naver, Daum, or Yahoo, and an application may include a Naver application, a Daum application, or Yahoo application executable on a mobile terminal.

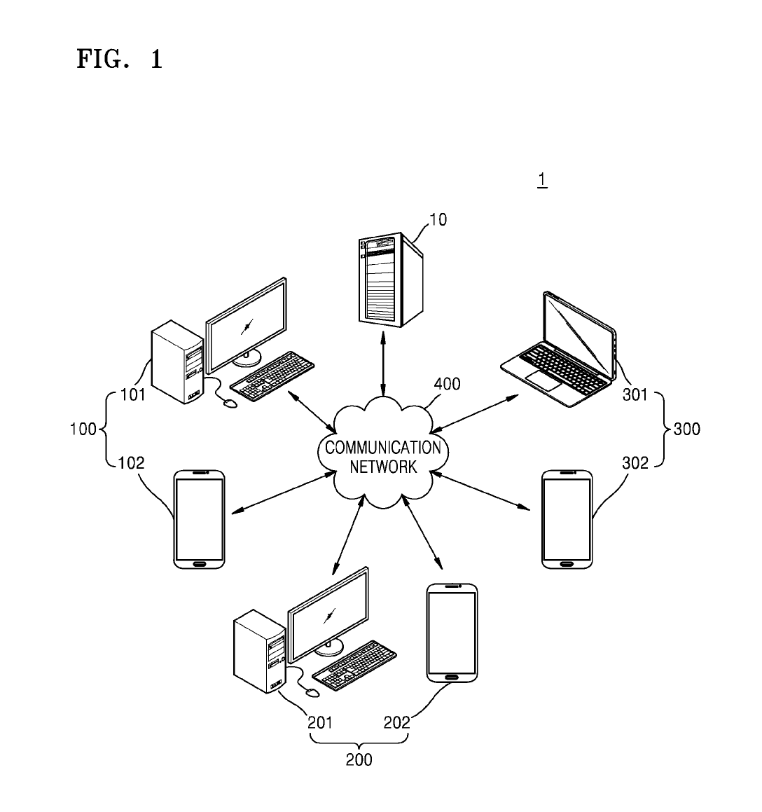

Herein, a “first terminal (refer to 100 of FIG. 1)” and a “second terminal (refer to 200 of FIG. 1)” include devices manipulated by a first user, for example, a mobile terminal, such as a laptop, a handheld device, a smart phone (refer to 102 and 202 of FIG. 1), or a tablet personal computer (PC), a general wired/wireless telephone, a desktop computer (refer to 101 and 201 of FIG. 1), or an arbitrary device using, or directly or indirectly connected to, one of the mobile terminal, the general wired/wireless telephone, and the smart phone. The first and second terminals are not limited thereto, and may be any terminal capable of browsing a web as described above. According to an embodiment, for example, the first terminal may be a desktop computer displaying a webpage of a search portal and the second terminal may be a mobile terminal executing a search portal application. Alternatively, the first and second terminals may be a mobile terminal displaying a webpage of a search portal and executing a search portal application.

Herein, a “third terminal (refer to 300 of FIG. 1)” may include a device manipulated by a second user, for example, a mobile terminal, such as a laptop, a handheld device, a smart phone (refer to 302 of FIG. 1), or a tablet PC, a general wired/wireless telephone, a desktop computer (refer to 301 of FIG. 1), or an arbitrary device using, or directly or indirectly connected to, one of the mobile terminals, the general wired/wireless telephone, and the smart phone. Herein, a “second user” may include an advertiser, a business owner, or a worker working in an advertising company or a company operated by an advertiser or a business owner, and moreover, may include an advertising company or a company itself. For example, the second user may include any company capable of providing a service to a first user, such as a specialized service company related to law, consulting, real estate, loan consulting, or an agent, a beauty service company related to a hair shop, a nail shop, plastic surgery, skin, or cosmetics, a transport service company related to a chauffeur service, a call-taxi, a dispatch rider service, a parcel service, or freight, an interior design and repair service company related to interior design, an on-site service, material sales, or a repair shop, a health and fitness service company related to a fitness center, various lessons related to exercises, or fitness products, a leisure and entertainment service company related to travel, leisure, a hobby, or accommodation, an education service company related to a private educational institute, private lessons, or an institution, or a high value service company related to a car, membership, or a luxury leisure product.

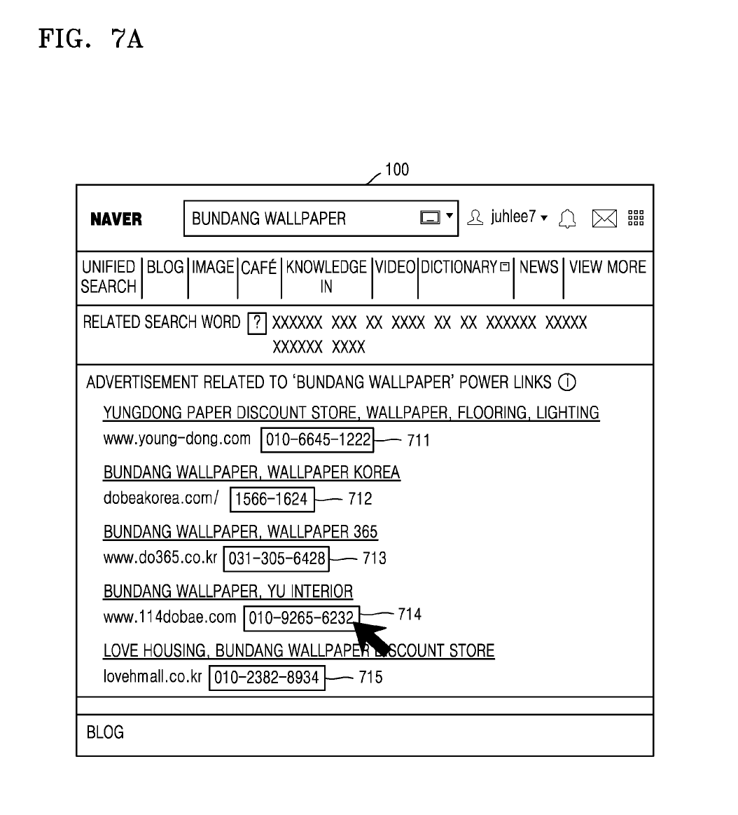

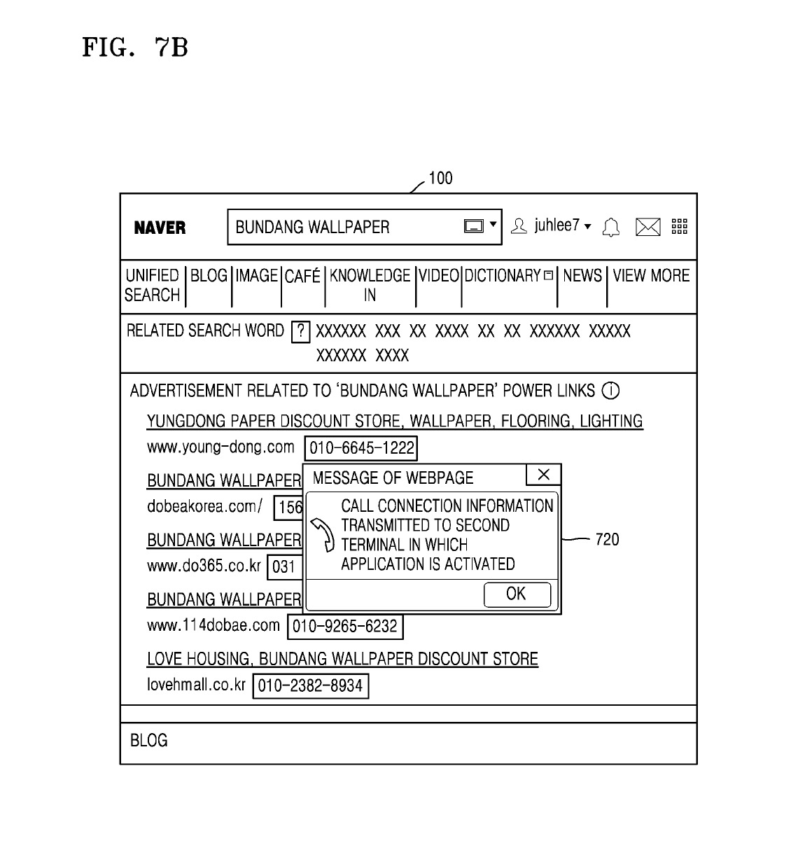

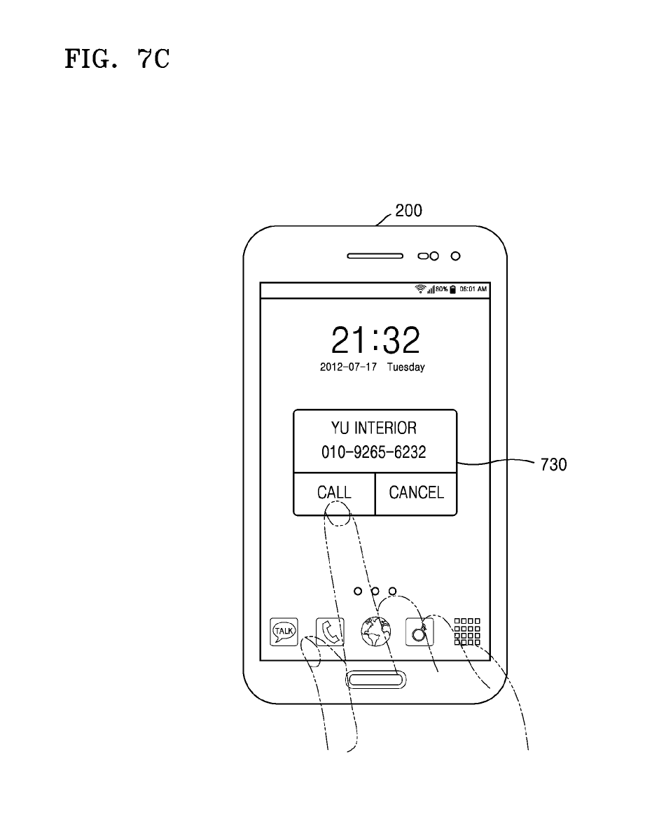

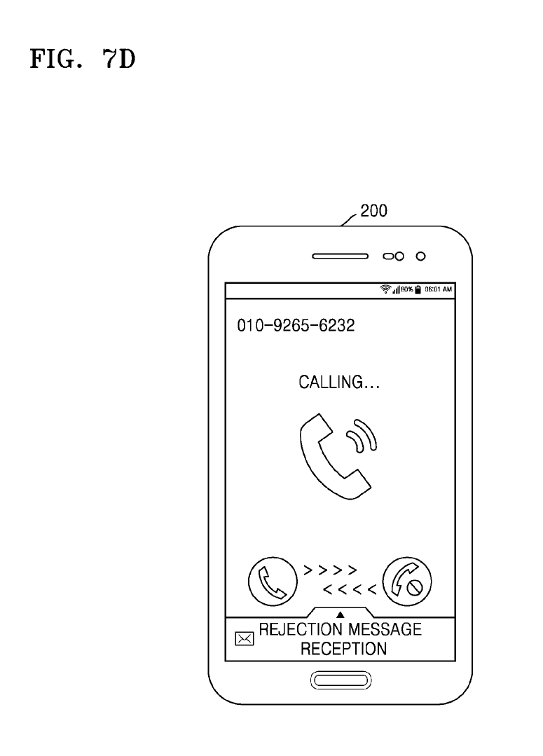

Herein, “calling route information (information of an outgoing call)” may include various types of information displayed on the third terminal and describe how the first user inputs a phone number of the second user to the second terminal. For example, when the first user tries to call the second user by selecting a phone number link object (refer to any one of 711 through 715 of FIG. 7A) provided to the first user through a network, calling route information may be <call made by clicking phone number in search advertisement region>. Also, when the first user tries to call the second user by selecting the phone number link object (refer to any one of 711 through 715 of FIG. 7A) provided to the first user through the network, the calling route information may include various types of information indicating how the phone number of the second user is input, such as information <input from network>, information <direct dial input> if the first user tries to call the second user by pressing a dial on the second terminal, or information <connection via QR code recognition> if the first user tries to call the second user by recognizing a quick response (QR) code by using the second terminal. Such calling route information may include some of call information of the first user or information processed according to the call information of the first user.

One or more embodiments will be described below in more detail with reference to the accompanying drawings. Those components that are the same or are in correspondence are rendered the same reference numeral regardless of the figure number, and redundant explanations are omitted.

FIG. 1 is a drawing for schematically describing a system 1 for providing call connection information, according to an embodiment. Referring to FIG. 1, the system 1 includes an apparatus 10 for providing call connection information, a first terminal 100, a second terminal 200, a third terminal 300, and a communication network 400.

The apparatus 10 according to an embodiment provides a webpage including a phone number link object enabling a call connection with the third terminal 300, to the first terminal 100 that is authenticated by using access identification (ID) information, and when a selection signal of the phone number link object is received from a first user, searches for the second terminal 200 that is authenticated by using the access ID information and is activated by executing an application corresponding to the webpage. When the second terminal 200 is found, the apparatus 10 provides call connection information including the phone number link object enabling the call connection with the third terminal 300 to the second terminal 200.

Here, the call connection information may include a combination of information including at least one of the phone number link object enabling the call connection with the third terminal 300, wherein the phone number link object is selected by the first user from the webpage, a representative advertisement title provided by the third terminal 300, a call interface enabling the call connection with the third terminal 300, and a cancel interface canceling the call connection with the third terminal 300. Also, the call connection may be made with the third terminal 300 by only selecting the phone number link object included in the call connection information, without having to select the call interface.

The apparatus 10 according to the current embodiment may be a search portal server described above for providing a search service.

Also, the apparatus 10 may provide calling route information with respect to the second terminal 200 to the third terminal 300 according to the selection of the call interface with respect to the phone number link object included in the call connection information displayed on the second terminal 200.

The first and second terminals 100 and 200 may display a webpage and/or an application provided by the apparatus 10, and the apparatus 10 that received the access ID information and a password of the first user through the first and second terminals 100 and 200 may perform first user authentication on the webpage and/or the application. Here, the phone number link object may be always displayed on the webpage and/or the application or may be displayed on the webpage and/or the application only when the first user authentication is completed.

The communication network 400 connects the apparatus 10 to the first through third terminals 100, 200 and 300. In other words, the communication network 400 denotes a communication network that provides an access route such that the first through third terminals 100, 200 and 300 access the apparatus 10 to transfer data. Examples of the communication network 400 include wired networks, such as a local area network (LAN), a wide area network (WAN), a metropolitan area network (MAN), and an integrated service digital network (IDSN), and wireless networks, such as a wireless LAN, a code division multiple access (CDMA) network, Bluetooth, and a satellite communication network, but are not limited thereto.

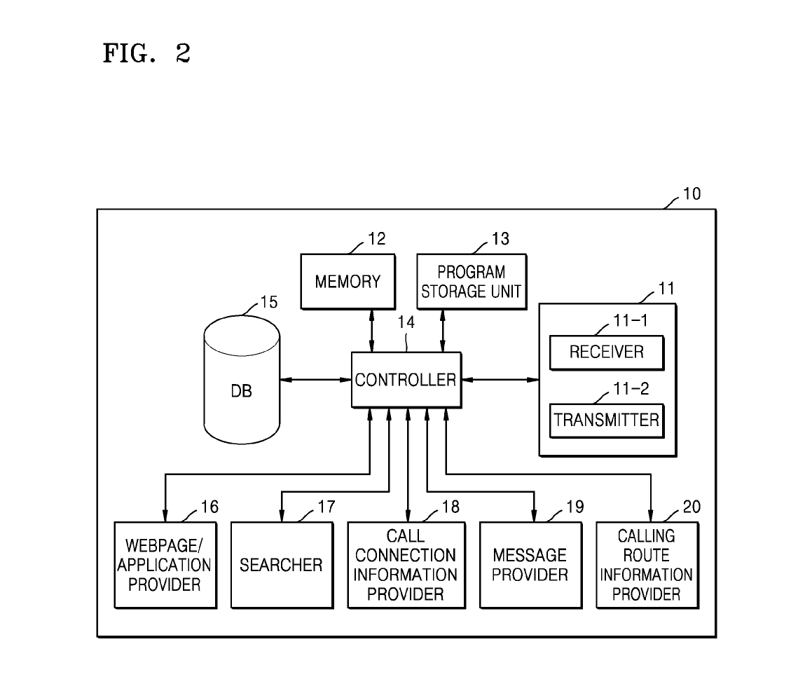

FIG. 2 is a block diagram of a detailed structure of the apparatus 10 for providing information, which is included in the system 1 of FIG. 1, according to an embodiment. Referring to FIG. 2, the apparatus 10 includes a communicator 11, a memory 12, a program storage unit 13, a controller 14, a database (DB) 15, a webpage/application provider 16, a searcher 17, a call connection information provider 18, a message provider 19, and a calling route information provider 20.

The communicator 11 interworks with the communication network 400 to provide a communication interface required to provide signals transferred between the apparatus 10 and the first through third terminals 100, 200 and 300 in the form of packet data. The communicator 11 includes a receiver 11-1 and a transmitter 11-2. The receiver 11-1 may receive a webpage/application provision request from the first and second terminals 100 and 200, and receive a selection signal of the phone number link object enabling the call connection with the third terminal from the first terminal 100. The transmitter 11-2 may transmit webpage/application information to the first and second terminals 100 and 200 in response to the webpage/application provision request, transmit the call connection information to the second terminal 200, transmit various messages to the first terminal 100 and/or the second terminal 200 in a form of a notification window, and transmit the calling route information with respect to the second terminal 200 to the third terminal 300.

Here, the webpage/application provision request received from the first and second terminals 100 and 200 may be a request to provide a certain page, such as a main page of a portal site, a first detail page providing a search result corresponding to an input search word or keyword, or a second detail page including detail information related to a website selected by the first user from among websites displayed on the first detail page.

The communicator 11 may be an apparatus including hardware and software required to transmit and receive a signal, such as a control signal or a data signal, to and from another network device via wired/wireless connection.

The memory 12 permanently or temporarily stores data processed by the controller 14. Here, the memory 12 may be a magnetic storage media or a flash storage media, but an embodiment is not limited thereto.

The program storage unit 13 stores control software that performs an operation of calculating a search result according to a request from the first or second user, an operation of searching for the second terminal 200 activated by executing an application corresponding to a webpage, an operation of generating the call connection information including the phone number link object, and an operation of generating the calling route information with respect to the second terminal 200.

The controller 14 is a type of a central processing apparatus, and controls the overall operations of authenticating the first user by using the access ID information and the password received from the first and second terminals 100 and 200, and providing the webpage/application to the first and second terminals 100 and 200 upon receiving the webpage/application provision request from the first and second terminals 100 and 200. The controller 14 controls the overall operations of searching for the second terminal 200 activated by executing an application in response to a phone number link object signal enabling a call connection with the third terminal 300 selected by a user from a webpage displayed on the first terminal 100 that is authenticated. The controller 14 controls the overall operations of generating the call connection information including the phone number link object and providing the call connection information to the second terminal 200. The controller 14 controls the overall operations of providing the calling route information with respect to the second terminal 200 to the third terminal 300 according to selection of a call interface with respect to the phone number link object included in the call connection information displayed on the second terminal 200. As such, the controller 14 control the overall operations related to transmitting and receiving of information between the first through third terminals 100, 200 and 300.

The DB 15 includes a call connection DB storing the call connection information provided by the apparatus 10. Here, the call connection DB may store the phone number link object related to the third terminal 300, information related to arrangement of the phone number link object, and information related to a contacting method according to the selection of the phone number link object, such as phone call connection, instant message transmission, or email transmission. Also, the DB 15 may further include a user DB storing user information. Here, the user information may include basic information of the user, such as name, affiliation, personal data, gender, age, and contact number, information related to authentication, such as access ID information and password, information related to access, such as access country, access location, access device, and access network environment, and history information including a history of accessing a webpage and/or an application.

Upon receiving the webpage/application provision request from the first and second terminals 100 and 200, the webpage/application provider 16 provides the webpage/application information received from the DB 15 under control of the controller 14 to the first and second terminals 100 and 200. Here, the webpage/application information may include the main page including the phone number link object enabling the call connection with the third terminal 300, the first detail page, and/or the second detail page. Also, the webpage and/or the application displayed on the first and second terminals 100 and 200 may be authenticated by using the same access ID information.

When the phone number link object signal enabling the call connection with the third terminal 300 selected by the first user from the webpage displayed on the first terminal 100 is received through the receiver 11-1, the searcher 17 searches for the second terminal 200 that is activated by executing the application (for example, a Naver application) corresponding to the webpage (for example, a Naver search portal). The searcher 17 monitors terminals that are authenticated by using the access ID information, and when the phone number link object signal enabling the call connection with the third terminal 300 is received from the first terminal 100 that is authenticated by using the access ID information, searches for the second terminal 200 that is authenticated by using the same access ID information as the first terminal 100 from among a plurality of the second terminals 200. According to an embodiment, the searcher 17 may be unable to find the second terminal 200 that is authenticated by using the same access ID information as the first terminal 100.

The call connection information provider 18 generates the call connection information including the phone number link object, and provide the call connection information to the second terminal 200 found by the searcher 17. Here, the call connection information may be provided to the second terminal 200 through the transmitter 11-2, in the form of a push message in a notification window. Since the push message is transmitted to the second terminal 200 without through a mobile carrier network, the push message may be transmitted to a user in real-time, and costs of transmitting messages may be reduced and marketing effects may be increased.

According to an embodiment, when the second terminal 200 is not found by the searcher 17, the call connection information provider 18 may search history information of an application that is authenticated by using the same access ID information as the first terminal 100, and provides the call connection information to a terminal having the history information. According to an embodiment, when the second terminal 200 is not found by the searcher 17 and the history information does not exist, the call connection information provider 18 may provide the call connection information to a contact number (for example, a terminal number) included in the user information stored in the DB 15.

When the call connection information is transmitted to the second terminal 200, the message provider 19 provides a first message indicating that the call connection information is transmitted to the second terminal 200 to the webpage displayed on the first terminal 100. Here, the first message may be displayed on the webpage of the first terminal 100 in the form of a notification window.

According to an embodiment, when the second terminal 200 that is authenticated by using the same access ID information as the first terminal 100 is not found after the phone number link object enabling the call connection with the third terminal 300 is received from the first terminal 100, the message provider 19 provides a second message indicating that it is possible to transmit the call connection information to the second terminal 200 when the application of the second terminal 200 is authenticated to the webpage of the first terminal 100. According to an embodiment, when the phone number link object signal is received while the webpage displayed on the first terminal 100 is not authenticated, the message provider 19 provides a third message indicating that it is possible to transmit the call connection information to the second terminal 200 when the webpage is authenticated to the webpage of the first terminal 100. According to an embodiment, when the phone number link object signal is received while the webpage of the first terminal 100 and the application of the second terminal 200 are not authenticated by using the same access ID information, the message provider 19 provides a fourth message indicating that it is possible to transmit the call connection information to the second terminal 200 when the webpage of the first terminal 100 and the application of the second terminal 200 are authenticated to the webpage of the first terminal 100.

According to an embodiment, when the webpage of the first terminal 100 and the application of the second terminal 200 are authenticated by using the same access ID information, the controller 14 displays, on the webpage of the first terminal 100, the phone number link object enabling the call connection with the third terminal 300 such that the phone number link object is activated and selectable. According to an embodiment, when only one of the webpage of the first terminal 100 and the application of the second terminal 200 is authenticated by using the access ID information or when neither of the webpage of the first terminal 100 and the application of the second terminal 200 is authenticated by using the access ID information, the controller 14 provides, to the webpage of the first terminal 100 through the message provider 19, a fifth message indicating that the phone number link object enabling the call connection with the third terminal 300 is activated and selectable when the webpage of the first terminal 100 and the application of the second terminal 200 are authenticated.

Generally, in order to make a call to the third terminal 300 by looking at the webpage displayed on the first terminal 100, the webpage including the phone number link object of the third terminal 300, the phone number link object is viewed on the first terminal 100, a phone number of the third terminal 300 is input by using the second terminal 200, a typing error in the phone number is checked, and then a call button is input to make the call on the third terminal 300.

Accordingly, when the webpage of the first terminal 100 and the application of the second terminal 200 corresponding to the webpage are both authenticated, the apparatus 10 according to an embodiment pushes the phone number link object selected by the first user from the webpage of the first terminal 100 to the application of the second terminal 200 and enables the call connection with the phone number link object through the second terminal 200, thereby providing convenience to the first user. Also, when the webpage of the first terminal 100 and the application of the second terminal 200 are both authenticated, the apparatus 10 according to an embodiment pushes the phone number link object included in the detail information related to the information selected by the first user from the webpage of the first terminal 100 and enables the call connection with the phone number link object through the second terminal 200, thereby providing convenience to the first user.

The calling route information provider 20 compares first call information related to the first and second terminals 100 and 200 according to the selection signal of the phone number link object and second call information related to a call signal from the third terminal 300 driven according to the selection signal, and displays, on the third terminal 300, some of the first call information based on a matching determination result of the selection signal and the call signal.

The components or units 16-20 of the apparatus 10, specifically, the webpage/application provider 16, the searcher 17, the call connection information provider 18, the message provider 19, and the calling route information provider 20 are functions performed by a computer processor capable of being programmed and in communication with the controller 14. Each of these functions may be performed separately in a dedicated processor, or all the functions may be performed by one or more computer processors. The functions of the components or units 16-20 may be implemented as computer programs including code or instructions that may be hardcoded or programmed directly in the computer processor, or stored in a separate storage medium (not shown) and executed by the computer processor.

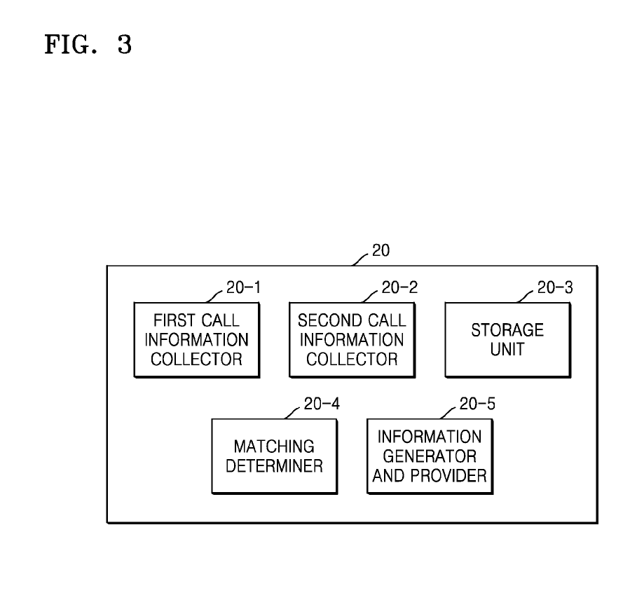

FIG. 3 is a block diagram of a detailed structure of a calling route information provider 20 included in the apparatus 10 of FIG. 2, according to an embodiment. Referring to FIG. 3, the calling route information provider 20 includes a first call information collector 20-1, a second call information collector 20-2, a storage unit 20-3, a matching determiner 20-4, and an information generator and provider 20-5.

The first call information collector 20-1 collects first call information as call information of the first and second terminals 100 and 200 according to selection of the phone number link object displayed on the webpage of the first terminal 100. Here, the first call information may include at least one of service details provided to the phone number link object received from the first terminal 100, time information of selecting the phone number link object received from the first terminal 100, a phone number linked to the phone number link object, the first user who selected the phone number link object, a phone number of the second terminal 200, time information when the second terminal 200 makes a call to the third terminal 300, call duration information of the call between the second and third terminals 200 and 300, and termination time information when the call between the second and third terminals 200 and 300 has ended. The first call information may be stored in the storage unit 20-3.

According to an embodiment, when the first user has selected the phone number link object from the webpage of the first terminal 100, the first call information collector 20-1 may extract a search keyword used by the first user. For example, when call connection information is output from the second terminal 200 as the first user selects a phone number link object from search results obtained by using <Bundang wallpaper> as a search keyword from a webpage displayed on the first terminal 100, the first call information collector 20-1 may extract <Bundang wallpaper> as the search keyword. The first call information collector 20-1 may collect information about the search keyword that provided the phone number link object. The information about the search keyword may include information about which keyword exposed the phone number of the second user. Thus, when a call is made to the third terminal 300, the second user may determine which search keyword led to the call.

The second call information collector 20-2 collects second call information about a call signal from the third terminal 300. Here, the second call information may include at least one of time information of the call signal, the phone number of the third terminal 300, the phone number of the second terminal 200, call duration information of the call between the second and third terminals 200 and 300, termination time information when the call between the second and third terminals 200 and 300 has ended. The second call information may be stored in the storage unit 20-3.

The storage unit 20-3 stores the first call information and the second call information described above. Also, the storage unit 20-3 may store a source code. Here, the source code may include information that is matched to each of general types of calling routes and coded. For example, when a calling route is <received from a main page> of the first terminal 100, the source code may be <0001>, and when a calling route is <received from a contact list> of the first terminal 100, the source code may be <0002>. However, the source codes are not limited thereto, and may vary. Also, the storage unit 20-3 may store information about a clicked region, a clicked time, a clicked phone number, and a clicked keyword from the webpage of the first terminal 100.

The matching determiner 20-4 may track the first user by matching the first call information collected by the first call information collector 20-1 and the second call information collected by the second call information collector 20-2. The matching determiner 20-4 may determine whether the first call information and the second call information match each other by comparing a time when the phone number link object is selected from the webpage of the first terminal 100 and a time when the call signal is received by the third terminal 300 because there is generally only a small time difference between when the phone number link object is selected and when a call button is input. For example, the matching determiner 20-4 may determine that the first call information and the second call information match each other if the time difference is within several seconds. As such, a time difference for determining whether the first call information and the second call information match each other may be set by adjusting a variable of matching determining algorithm.

According to an embodiment, the matching determiner 20-4 determines whether the first call information and the second call information match each other by comparing the time when the second terminal 200 called the third terminal 300 according to the selection of the phone number link object, which is included in the first call information, and the time when the call signal is received, which is included in the second call information, by comparing a linked phone number included in the first call information and the phone number of the third terminal 300, which is included in the second call information, or by comparing a member who selected the phone number link object, which is included in the first call information, and the phone number of the second terminal 200, which is included in the second call information.

In detail, when the first user selects the phone number link object displayed on the webpage of the first terminal 100, the linked phone number of the phone number link object is copied to a phone number input window of the second terminal 200, and when the first user presses a call button, the first call information is transmitted to the third terminal 300. The first call information may include at least one of the type of a service being used, the region clicked and selected by the first user, the time when the region is clicked and selected, the linked phone number, and the phone number of the first user. In addition, accuracy of the matching may be increased by using various information collectable based on each of the phone numbers of the second and third terminals 200 and 300.

For example, the accuracy of the matching may be increased by collecting not only the phone number of the first user who clicked the phone number link object from the webpage of the first terminal 100, but also de-identification personal information collectable online, such as location information and the serial number of the second terminal 200, at the moment the phone number link object is clicked, when the call signal is received by the third terminal 300, determining a method of collecting location information based on a mobile carrier base station through the phone number of the second terminal 200 and various types of information collectable online, and then comparing the similarity between information collected by the second and third terminals 200 and 300.

When the matching determiner 20-4 determines that the first call information and the second call information match each other, the information generator and provider 20-5 generates and transmits information including some of the first call information or the calling route information processed based on the information including some of the first call information to the third terminal 300 to be displayed. Information displayed on the third terminal 300 may include at least one of service details provided to the phone number link object, the time when the phone number link object is selected, the linked phone number linked to the phone number link object, the member who selected the phone number link object, the phone number of the second terminal 200, and the search keyword that led to the phone number link object.

However, when the matching determiner 20-4 determines that the first call information and the second call information do not match each other, the information generator and provider 20-5 may only generate and transmit the phone number of the second terminal 200 to the third terminal 300, and only the phone number of the second terminal 200 may be displayed on the third terminal 300.

If the phone number of the first terminal 100 and/or the second terminal 200 is not collected by the first call information collector 20-1, for example, if the second terminal 200 does not provide the phone number of the second terminal 200, and when the first user selects the phone number link object included in the call connection information of the second terminal 200, the third terminal 300 may detect that a call is received, and the matching determiner 20-4 may determine whether the first call information, from which the phone number of the second terminal 200 is excluded and the second information stored in the first storage unit 20-3 match each other.

As such, useful information about a calling route may be provided to a callee by providing, to the third terminal 300, information about how a caller (the first user) obtained a phone number of the callee (the second user) during call connection between the third terminal 300 and the second terminal 200 to which the phone number link object is transmitted according to a selection on the webpage of the first terminal 100.

The components or units 20-1 to 20-5 of the calling route information provider 20 are functions performed by the computer processor described above that executes the overall functions of the calling route information provider 20. Each of the functions of the components or units 20-1 to 20-5 may be implemented as computer programs including code or instructions that may be hardcoded or programmed directly in the computer processor, or stored in a separate storage medium (not shown) and executed by the computer processor.

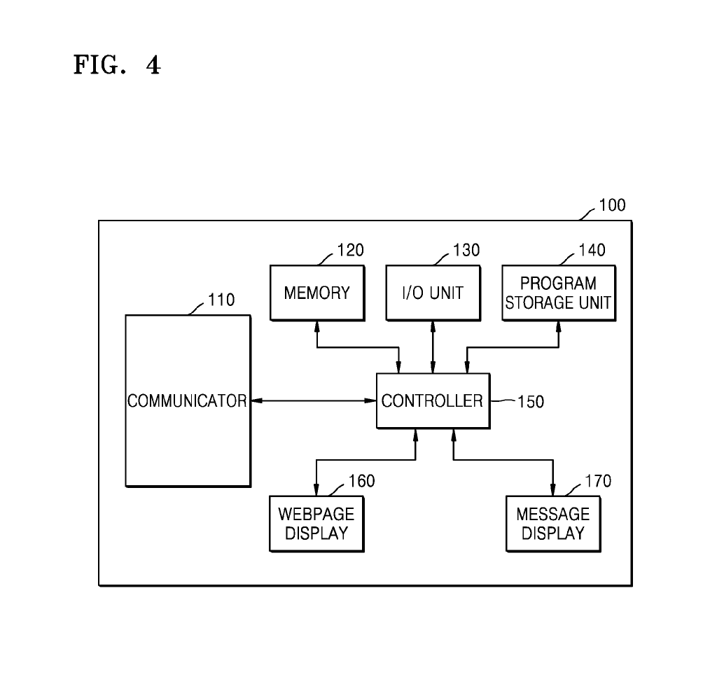

FIG. 4 is a block diagram of a detailed structure of the first terminal 100 included in the system 1 of FIG. 1, according to an embodiment. Referring to FIG. 4, the first terminal 100 includes a communicator 110, a memory 120, an input/output (I/O) unit 130, a program storage unit 140, a controller 150, a webpage display 160, and a message display 170.

The communicator 110 may be an apparatus including hardware and software required to transmit and receive a signal, such as a control signal or a data signal, to and from another network apparatus, such as the apparatus 10, via wired/wireless connection. For example, the communicator 110 may include a short-range wireless communicator or a mobile communicator. Examples of the short-range wireless communicator include a Bluetooth communicator, a Bluetooth low energy (BLE) communicator, a near field communicator, a wireless local area network (WLAN) (Wi-Fi) communicator, a Zigbee communicator, an infrared data association (IrDA) communicator, a Wi-Fi direction (WFD) communicator, an ultra wideband (UWB) communicator, and an Ant+communicator, but are not limited thereto. The mobile communicator transmits and receives a wireless signal to and from at least one of a base station, an external terminal, and a server on a mobile communication network. Here, the wireless signal may include data in various forms according to transmission and reception of a voice call signal, an image phone call signal, or a text/multimedia message.

The memory 120 may temporarily or permanently store data processed by the controller 150, or temporarily or permanently store content data transmitted to the first terminal 100. Here, the memory 120 may include a magnetic storage media or a flash storage media, but is not limited thereto.

The I/O unit 130 may include a touch recognition display controller or any one of various I/O controllers. For example, the touch recognition display controller may provide an output interface and an input interface between the first terminal 100 and a user. The touch recognition display controller may transmit and receive an electric signal to and from the controller 150. Also, the touch recognition display controller displays a visual output to the user, wherein the visual output includes text, graphics, an image, a video, or a combination thereof. The I/O unit 130 may be, for example, a display such as an organic light-emitting display (OLED) or a liquid crystal display (LCD) capable of touch recognition.

The program storage unit 140 may include control software performing an operation of receiving, from the apparatus 10, a search result and a webpage, an operation of receiving a selection signal of a search result from the I/O unit 130 of the first terminal 100, an operation of displaying a phone number link object on a webpage, and an operation of receiving a selection signal of a phone number link object.

The controller 150 is a type of a central processing apparatus, and controls the overall operations of downloading content in the first terminal 100. In other words, the controller 150 may provide various function, such as driving the control software included in the program storage unit 140, displaying the webpage and the phone number link object on the first terminal 100 by controlling the webpage display 160, and displaying any one of the first through fifth messages by controlling the message display 170.

Here, the controller 150 may include any type of apparatus capable of processing data, such as a processor. Here, the processor may be understood as, for example, a data processing device included in hardware and including a circuit physically configured to perform a function expressed using code or instructions included in a program. Examples of the data processing device included in hardware may include various processing devices such as a microprocessor, a central processing unit (CPU), a processor core, a multiprocessor, an application-specific integrated circuit (ASIC), a field programmable gate array (FPGA), etc., but embodiments are not limited thereto.

The webpage display 160 may display the webpage and the phone number link object received from the apparatus 10, under the control of the controller 150. Here, the phone number link object may be transmitted to the apparatus 10 through the communicator 110, as the first user selects the phone number link object through the I/O unit 130.

When the phone number link object is selected from the web page, the message display 170 may output one of the first through fifth messages generated by the apparatus 10.

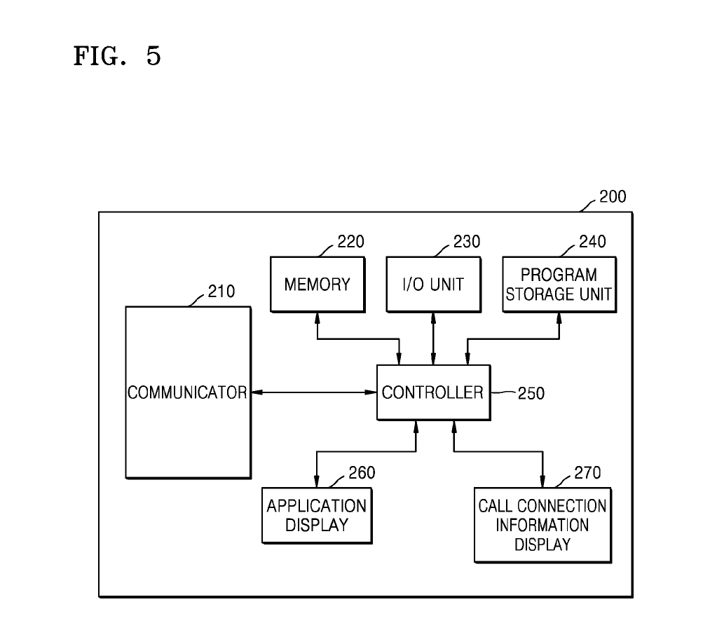

FIG. 5 is a block diagram of a detailed structure of the second terminal 200 included in the system 1 shown in FIG. 1, according to an embodiment. Referring to FIG. 5, the second terminal 200 includes a communicator 210, a memory 220, an I/O unit 230, a program storage unit 240, a controller 250, an application display 260, and a call connection information display 270. According to an embodiment, the first and second terminals 100 and 200 may be the same terminal. Since details about the communicator 210, the memory 220, and the I/O unit 230 of FIG. 5 are respectively the same as those of the communicator 110, the memory 120, and the I/O unit 130 of FIG. 4, details thereof are not provided again.

The program storage unit 240 stores control software performing an operation of downloading and executing an application from the apparatus 10 to display the application, an operation of receiving and displaying the call connection information, and an operation of receiving a selection signal from the I/O unit 230 of the second terminal 200.

The controller 250 is a type of a central processing apparatus and controls the overall operations of downloading content in the second terminal 200. In other words, the controller 250 may provide various functions, such as driving the control software included in the program storage unit 240, controlling the application display 260 to display the application on the second terminal 200, and controlling the call connection information display 270 to display the call connection information on the second terminal 200.

The application display 260 executes and displays the application received from the apparatus 10 under the control of the controller 250. When the application is executed, information indicating that the application is activated on the second terminal 200 may be transmitted to the apparatus 10.

The call connection information display 270 displays the call connection information generated by the apparatus 10 according to the phone number link object signal enabling the call connection with the third terminal 300 selected by the first user from the webpage of the first terminal 100.

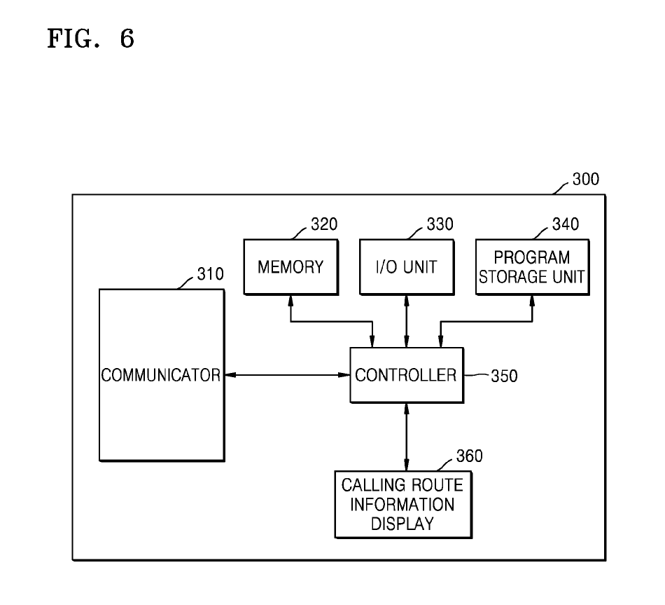

FIG. 6 is a block diagram of a detailed structure of the third terminal 300 included in the system 1 of FIG. 1, according to an embodiment. Referring to FIG. 6, the third terminal 300 includes a communicator 310, a memory 320, an I/O unit 330, a program storage unit 340, a controller 350, and a calling route information display 360. Since details about the communicator 310, the memory 320, and the I/O unit 330 of FIG. 6 are respectively the same as those of the communicator 110, the memory 120, and the I/O unit 130 of FIG. 4, details thereof are not provided again.

The program storage unit 340 includes control software for performing an operation of receiving and displaying the calling route information from the apparatus 10, and an operation of receiving a selection signal from the I/O unit 330 of the third terminal 300.

The controller 350 is a type of a central processing apparatus and may control the overall operations of downloading content in the third terminal 300. In other words, the controller 350 may provide various functions, such as driving the control software included in the program storage unit 340, and displaying the calling route information on the third terminal 300 by controlling the calling route information display 360.

The calling route information display 360 displays the calling route information received from the apparatus 10, under the control of the controller 350.

The components or units 160 and 170 of the first terminal 100, specifically the webpage display 160 and the message display 170; the components or units 260 and 270 of the second terminal 200, specifically the application display 260 and the call connection information display 270; and the component or unit 360 of the third terminal 300, specifically the calling route information display 360 are functions performed by a computer processor capable of being programmed. Each of these functions may be performed separately in a dedicated processor in their respective terminals 100, 200 or 300, or all the functions within each terminal may be performed by one or more computer processors within the respective terminals. The functions of the components 160, 170, 260, 270, and 360 may be implemented as computer programs including code or instructions that may be hardcoded or programmed directly in the computer processor, or stored in a separate storage medium (not shown) and executed by the computer processor.

FIGS. 7A through 7D illustrate examples of information-related screens provided by the apparatus 10 to the first and second terminals 100 and 200, according to embodiments. Referring to FIGS. 7A through 7D, FIG. 7A illustrates a first detail page obtained as a search word or keyword (for example, Bundang wallpaper) is input by the first user on the first terminal 100 in which a main page is authenticated by using access ID information. The first detail page shows accessible websites and phone number link objects 711 through 715 enabling call connection with the third terminal 300. The first detail page of FIG. 7A shows a website information screen displaying the websites and the phone number link objects 711 through 715, but an embodiment is not limited thereto, and the first detail page may show, together with the phone number link objects 711 through 715, news information, blog information, image information café information, map information, content information (a video, music, a document, a magazine, or a book), opencast information, shopping information, and advertisement information.

FIG. 7B displays a first message 720 provided from the apparatus 10 to the first terminal 100 according to the selection of the phone number link object 714 from the first detail page, wherein the first message 720 indicates that call connection information including the phone number link object 714 is transmitted to the second terminal 200 in which an application is activated. Here, the second terminal 200 in which the application is activated may be authenticated by using the same access ID information used to authenticate the webpage of the first terminal 100.

FIG. 7C shows call connection information 730 including a phone number link object provided to the second terminal 200 by the apparatus 10 according to the selection of the phone number link object 714 from the first detail page on the first terminal 100.

FIG. 7D shows a call connection state to the third terminal 300 according to the selection of the phone number link object included in the call connection information 730 displayed on the second terminal 200.

As such, when the webpage and the application corresponding to the webpage are both authenticated in the first and second terminals 100 and 200, the apparatus 10 may push the phone number link object selected by the first user from the webpage of the first terminal 100 to the application of the second terminal 200, and enable the call connection with the phone number link object on the second terminal 200, thereby providing convenience to the first user.

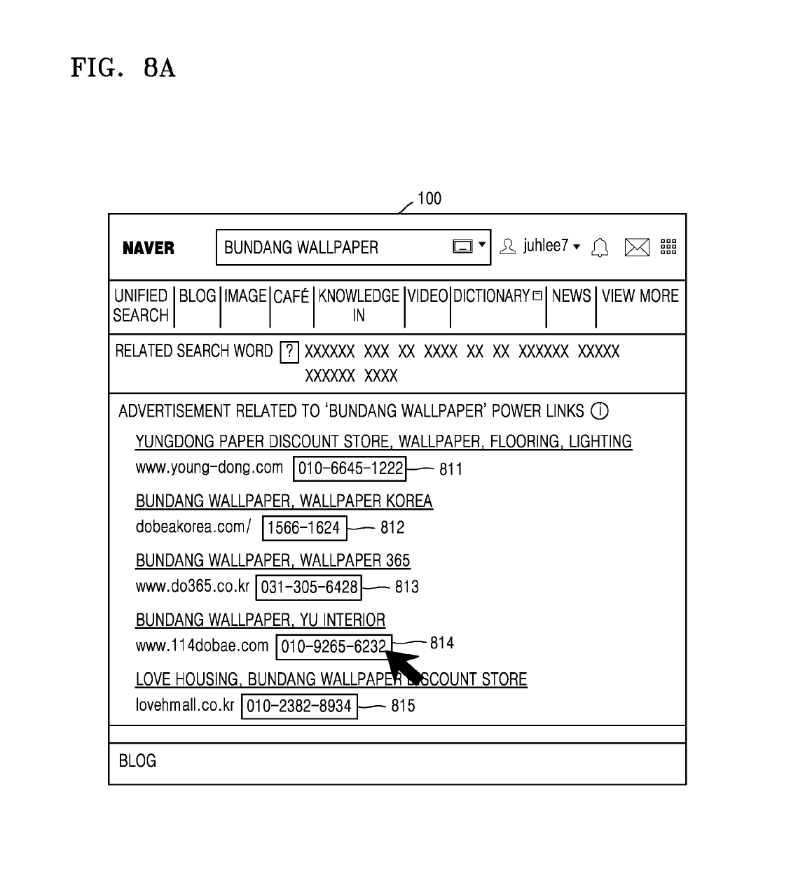

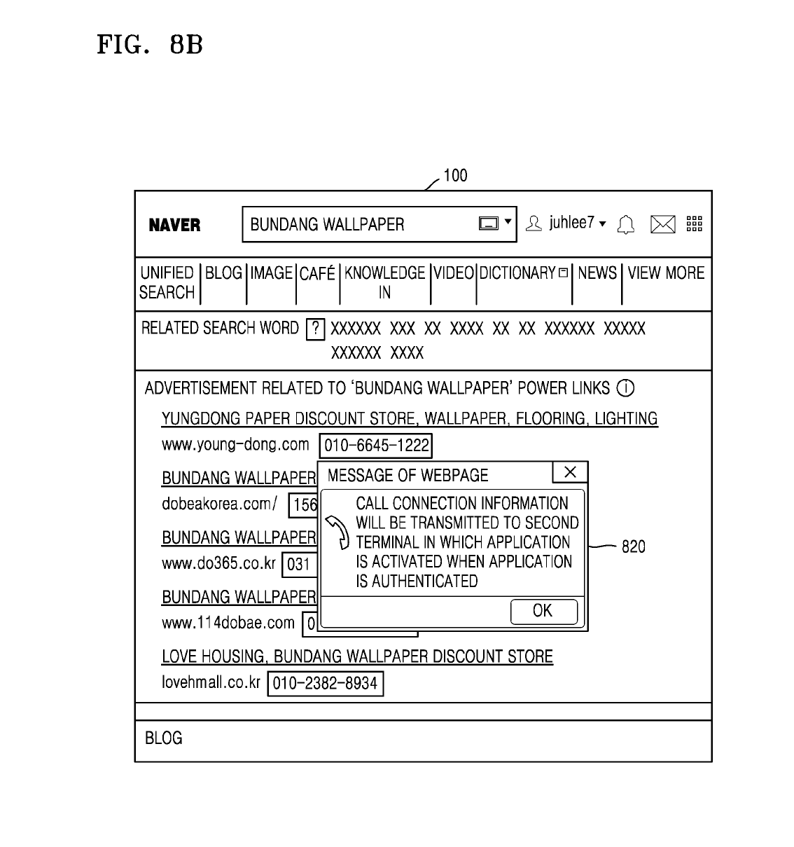

FIGS. 8A and 8B illustrate examples of information-related screens provided by the apparatus 10 to the first terminal 100, according to other embodiments. Referring to FIGS. 8A and 8B, FIG. 8A illustrates a first detail page obtained as the first user inputs a search word or a keyword into the first terminal 100 in which a main page is authenticated by using access ID information. The first detail page shows accessible websites and phone number link objects 811 through 815 enabling call connection with the third terminal 300, and the phone number link object 814 is selected from among the phone number link objects 811 through 815.

FIG. 8B illustrates a second message 820 output on the first detail page of the first terminal 100 when the apparatus 10 needs to transmit call connection information including a phone number link object to the second terminal 200 in which the application is activated, as the phone number link object 814 is selected, but the application of the second terminal 200 is not authenticated by using the same access ID information used to authenticate the main page of the first terminal 100. By outputting the second message 820, the application executable on the second terminal 200 may be induced to be authenticated.

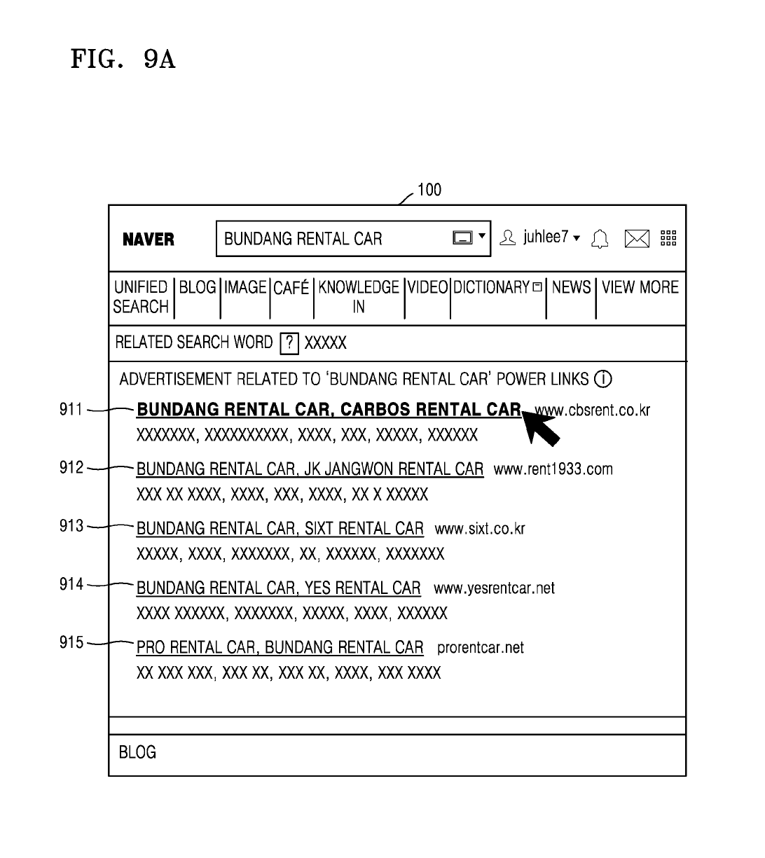

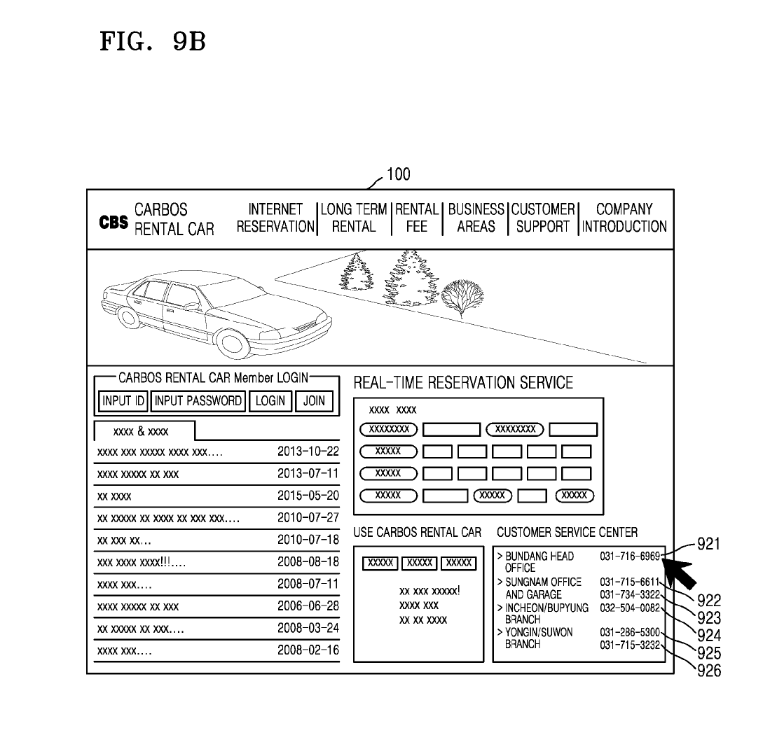

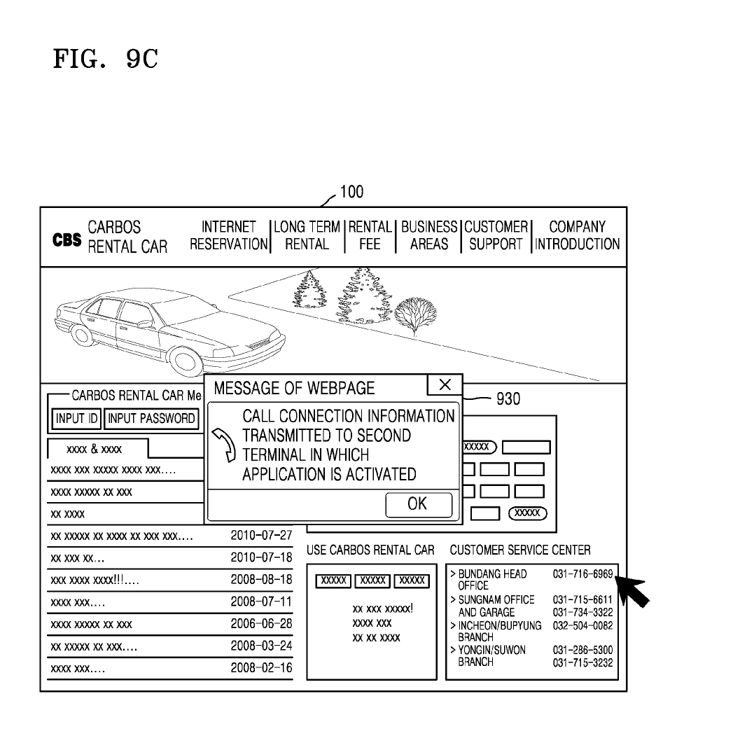

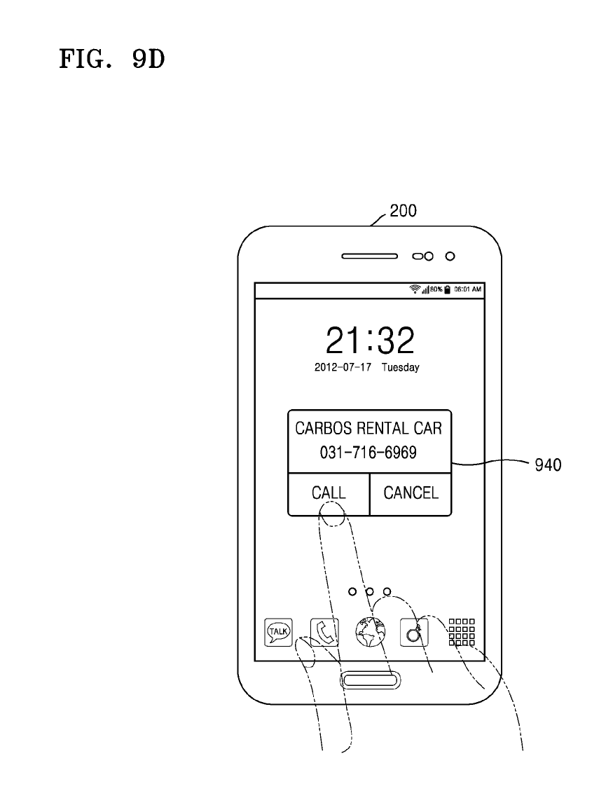

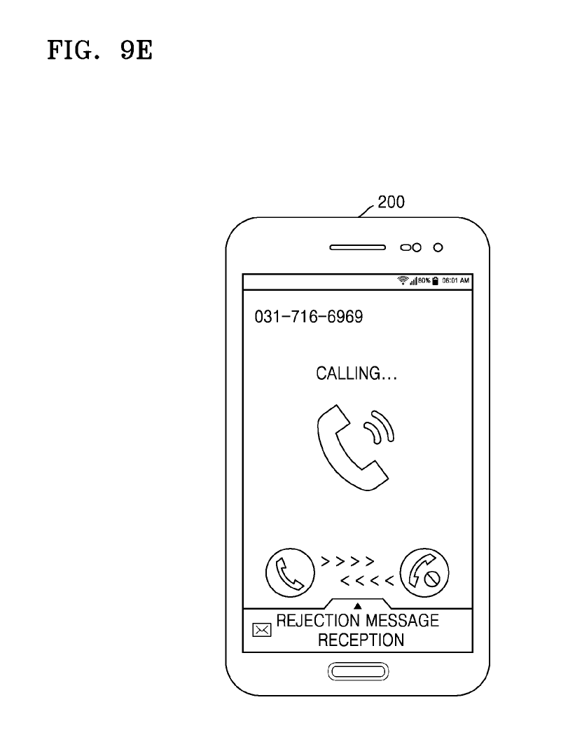

FIGS. 9A through 9E illustrate examples of information-related screens provided by the apparatus 10 to the first and second terminals 100 and 200, according to other embodiments. Referring to FIGS. 9A through 9E, FIG. 9A illustrates a first detail page obtained as the first user inputs a search word or a keyword (for example, Bundang rental car) into the first terminal 100 in which a main page is authenticated by using access ID information. In FIG. 9A, a phone number link object is not shown, but websites 911 through 915 including the search word are shown.

FIG. 9B illustrates a second detail page of the first terminal 100, which is obtained as the website 911 is selected from among the websites 911 through 915 displayed on the first terminal 100. The second detail page shows phone number link objects 921 through 926 enabling call connection with the third terminal 300.

FIG. 9C shows a first message 930 provided by the apparatus 10 to the first terminal 100 as the phone number link object 921 is selected from among the phone number link objects 921 through 926 displayed on the second detail page, wherein the first message 930 indicates that call connection information including a phone number link object is transmitted to the second terminal 200 in which the application is activated. Here, the application of the second terminal 200 may be authenticated by using the same access ID information used to authenticate the main page of the first terminal 100.

FIG. 9D shows call connection information 940 including a phone number link object provided by the apparatus 10 to the second terminal 200 as the phone number link object 921 is selected.

FIG. 9E shows a call connection state to the third terminal 300 as the phone number link object of the call connection information 940 is selected.

As such, when the webpage and the application corresponding to the webpage are both authenticated in the first and second terminals 100 and 200, the apparatus 10 may push the detail information related to the information selected by the first user from the first detail page of the first terminal 100, i.e., the phone number link object included in the second detail page, to the application of the second terminal 200, and enable the call connection with the phone number link object on the second terminal 200, thereby providing convenience to the first user.

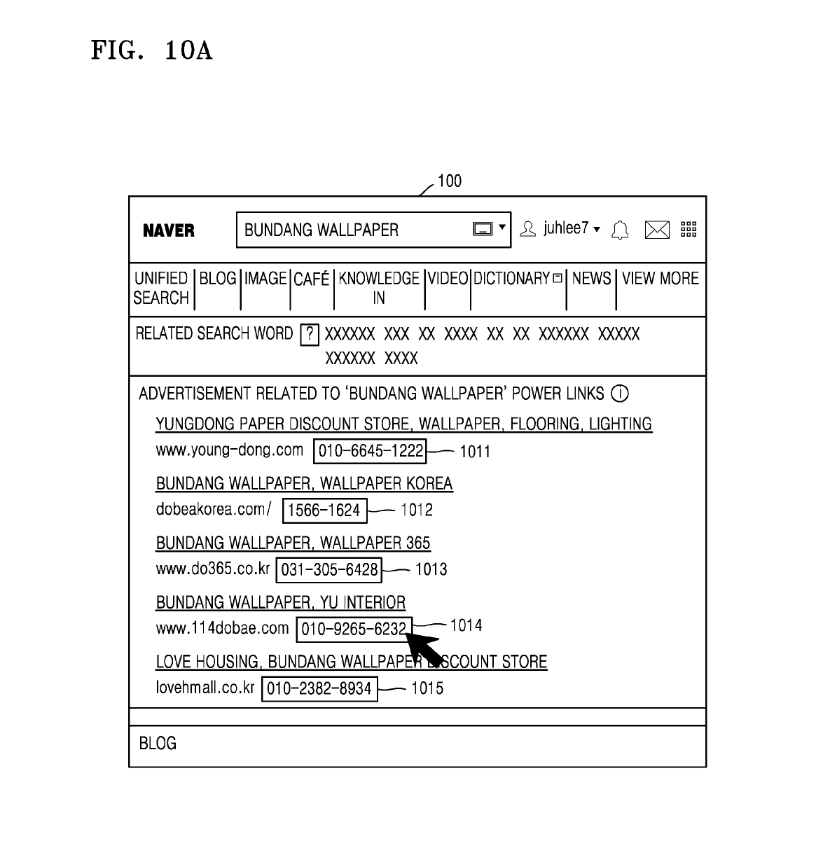

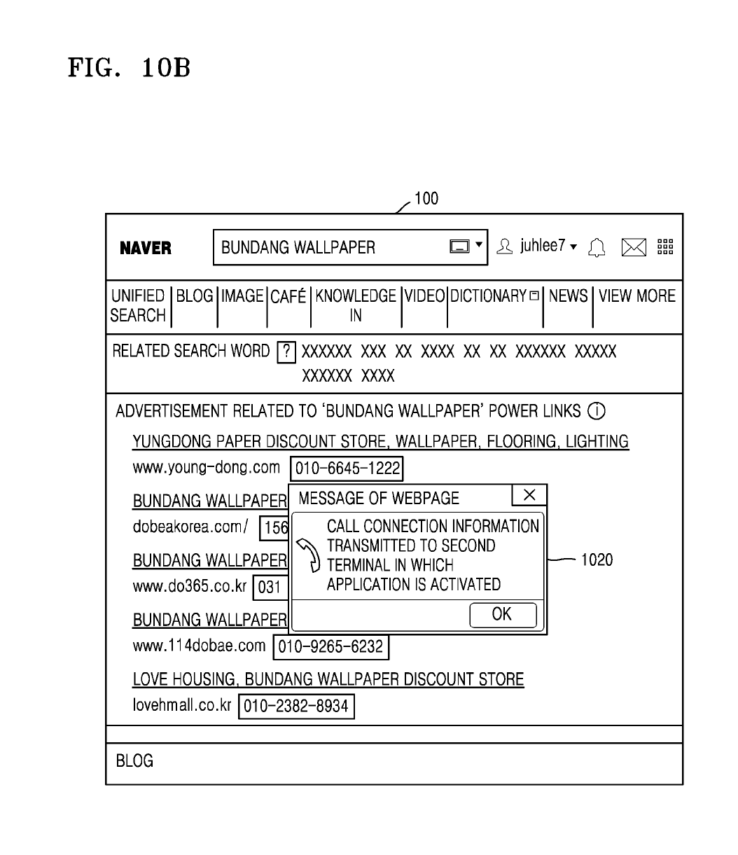

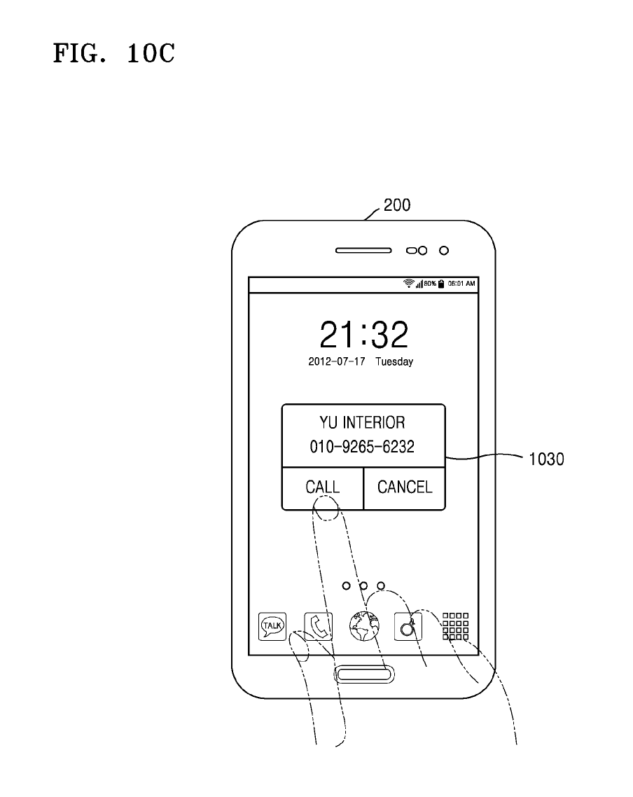

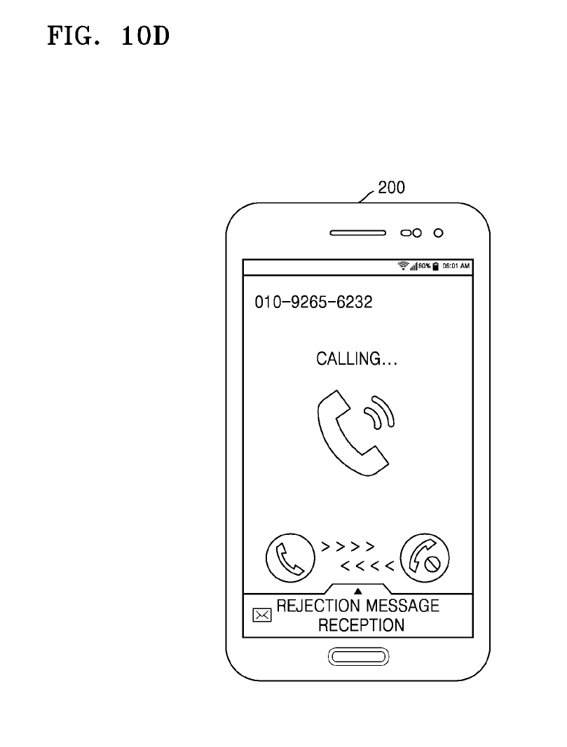

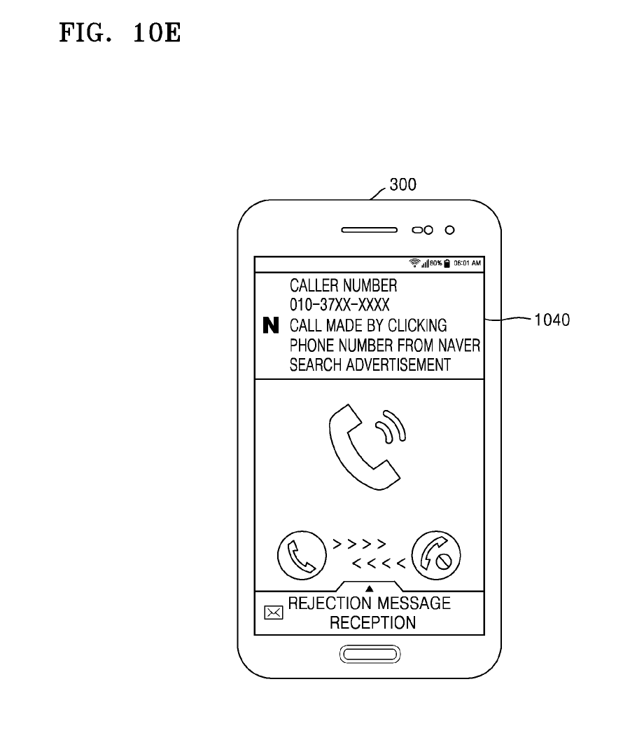

FIGS. 10A through 10E illustrate examples of information-related screens provided by the apparatus 10 to the first through third terminals 100, 200 and 300, according to other embodiments. Referring to FIGS. 10A through 10E, FIG. 10A illustrates a first detail page obtained as the first user inputs a search word or a keyword (for example, Bundang wallpaper) into the first terminal 100 in which a main page is authenticated by using access ID information. The first detail page of the first terminal 100 shows accessible websites and phone number link objects 1011 through 1015 enabling call connection with the third terminal 300.

FIG. 10B illustrates a first message 1020 provided from the apparatus 10 to the first terminal 100 as the phone number link object 1014 is selected from the first detail page of FIG. 10A, wherein the first message 1020 indicates that call connection information including a phone number link object is transmitted to the second terminal 200 in which an application is activated. Here, the application of the second terminal 200 is authenticated by using the same access ID information used to authenticate the main page of the first terminal 100.

FIG. 10C illustrates call connection information 1030 including a phone number link object, which is provided from the apparatus 10 to the second terminal 200 as the phone number link object 1014 is selected from the first detail page of the first terminal 100.

FIG. 10D illustrates a call connection state to the third terminal 300 as the phone number link object of the call connection information 1030 displayed on the second terminal 200 is selected.

FIG. 10E illustrates calling route information 1040 displayed on the third terminal 300 as the phone number link object of the second terminal 200 is selected.

As such, when the webpage and the application corresponding to the webpage are both authenticated in the first and second terminals 100 and 200, the apparatus 10 may push the phone number link object selected by the first user from the webpage of the first terminal 100 to the application of the second terminal 200, enable the call connection with the phone number link object on the second terminal 200, and provide, to the third terminal 300, information about how a caller (the first user) obtained a phone number of a callee (the second user) during call connection between the second and third terminals 300, thereby providing useful information about a calling route to the callee.

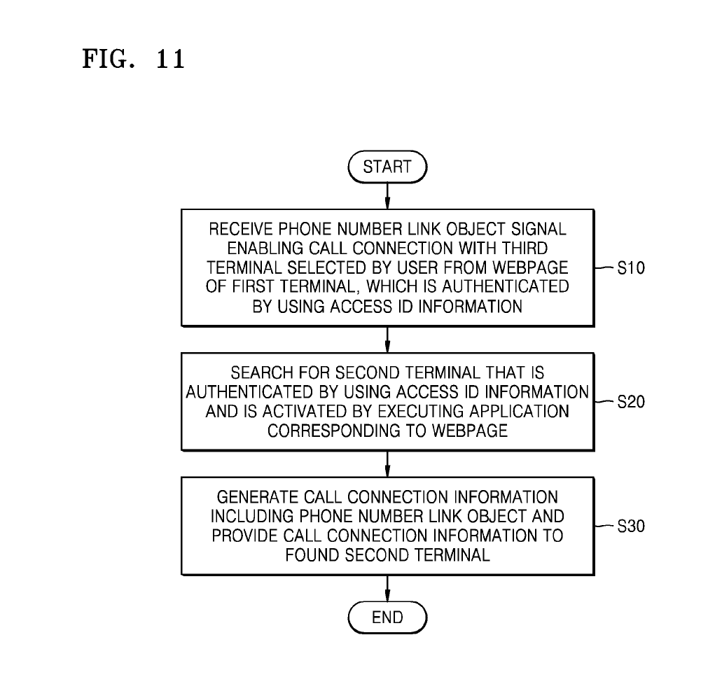

FIG. 11 is a flowchart of a method of providing information, according to an embodiment. While describing the method, details overlapping those of FIGS. 1 through 10E are not provided again. Referring to FIG. 11, the apparatus 10 receives a phone number link object signal enabling call connection with the third terminal 300 in operation S10, wherein the third terminal 300 may be an advertiser terminal selected by a user from a webpage of the first terminal 100 that is authenticated by using access ID information. According to an embodiment, the apparatus 10 may receive a selection signal of a phone number link object included in detail information (the second detail page described above) related to information selected by the user from the webpage of the first terminal 100.

When the phone number link object signal is received, the apparatus 10 searches for the second terminal 200 that is authenticated by using the same access ID information as the first terminal 100 and is activated by executing an application corresponding to the webpage, in operation S20.

When the second terminal 200 is found, the apparatus 10 generates call connection information including a phone number link object and provides the call connection information to the found second terminal 200, in operation S30.

According to an embodiment, when the second terminal 200 is not found, the apparatus 10 may search for history information of the application that is authenticated by using the access ID information, and provide the call connection information to a terminal having the history information. Alternatively, when the second terminal 200 is not found, the apparatus 10 may provide the call connection information to a phone number of a terminal that is authenticated. According to an embodiment, the apparatus 10 may provide any one of the first through fifth messages to the webpage of the first terminal 100.

According to an embodiment, the apparatus 10 may compare first call information related to the first and second terminals 100 and 200 according to the selection signal of the phone number link object displayed on the webpage of the first terminal 100, and second call information related to a call signal from the third terminal 300 driven according to the selection signal, and display some of the first call information on the third terminal 300 according to a matching determination result of the selection signal and the call signal.

According to one or more embodiments, when a webpage and an application corresponding to the webpage are both authenticated on different terminals or the same terminal, a phone number link object selected by a user from the webpage is pushed to the application to enable a call connection with the phone number link object on the different terminals or the same terminal, thereby providing convenience to the user.

According to one or more embodiments, when a webpage and an application corresponding to the webpage are both authenticated on different terminals or the same terminal, a phone number link object included in detail information related to information selected by a user from the webpage is pushed to the application to enable a call connection with the phone number link object on the different terminals or the same terminal, thereby providing convenience to the user.

According to one or more embodiments, during a call connection with a phone number link object on a terminal, a callee is notified about a route through which a caller obtained a phone number of the callee, thereby providing useful information about the route to the callee.

One or more of the above embodiments may be embodied in the form of a computer program that can be run in a computer through various elements. The computer program may be recorded on a non-transitory computer-readable recording medium. Examples of the non-transitory computer-readable recording medium include magnetic media (e.g., hard disks, floppy disks, and magnetic tapes), optical media (e.g., CD-ROMs and DVDs), magneto-optical media (e.g., floptical disks), and hardware devices specifically configured to store and execute program commands (e.g., ROMs, RAMs, and flash memories). Furthermore, the computer program can be transmitted and distributed in a network, e.g., software or an application.

The computer program may be designed and configured specially for the disclosure by those of ordinary skill in the field of computer software. Examples of the computer program include not only machine language codes prepared by a compiler but also high-level codes executable by a computer by using an interpreter.

The use of the terms “a” and “an” and “the” and similar referents in the context of describing one or more embodiments (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein.

Finally, the steps of all methods described herein can be performed in any suitable order unless otherwise indicated herein or otherwise clearly contradicted by context. The use of any and all examples, or exemplary language (e.g., such as“) provided herein, is intended merely to better illuminate the disclosure and does not pose a limitation on the scope of the disclosure unless otherwise claimed. Numerous modifications and adaptations will be readily apparent to those of ordinary skill in this art without departing from the spirit and scope of the disclosure.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. An apparatus for providing call connection information, the apparatus comprising:
a receiver configured to receive a phone number link object signal enabling a call connection with a third terminal selected by a user from a webpage on a first terminal, which is authenticated by using access identification (ID) information;
a searcher configured to search for a second terminal that is authenticated by using the access ID information and activated by using an application corresponding to the webpage on the first terminal; and
a call connection information provider configured to generate call connection information comprising a phone number link object and provide the call connection information to the second terminal found by the searcher.

2. The apparatus of claim 1, wherein the receiver is further configured to receive a selection signal of the phone number link object included in detail information related to information selected by the user from the webpage of the first terminal.

3. The apparatus of claim 1, wherein, when the second terminal is not found by the searcher, the call connection information provider searches for history information of the application and provides the call connection information to a terminal associated with the history information.

4. The apparatus of claim 1, wherein, when the second terminal is not found by the searcher, the call connection information provider provides the call connection information to a terminal number that is authenticated.

5. The apparatus of claim 1, further comprising a message provider configured to provide a first message indicating that the call connection information is transmitted to the second terminal, to the webpage of the first terminal.

6. The apparatus of claim 1, further comprising a calling route information provider configured to compare first call information related to the first and second terminals according to a selection signal of the phone number link object displayed on the webpage of the first terminal and second call information related to a call signal from the third terminal driven according to the selection signal, and display some of the first call information on the third terminal according to a matching determination result of the selection signal and the call signal.

7. The apparatus of claim 1, wherein the first and second terminals are a same terminal.

8. A method of providing call connection information, the method comprising:
receiving, by a receiver, a phone number link object signal enabling a call connection with a third terminal selected by a user from a webpage on a first terminal, which is authenticated by using access identification (ID) information;
searching for, by a searcher, a second terminal that is authenticated by using the access ID information and activated by using an application corresponding to the webpage on the first terminal; and
generating and providing, by a call connection information provider, call connection information comprising a phone number link object to the second terminal found by the searcher.

9. The method of claim 8, wherein the receiving comprises receiving a selection signal of the phone number link object included in detail information related to information selected by the user from the webpage of the first terminal.

10. The method of claim 8, wherein, when the second terminal is not found by the searcher, the generating and providing comprises searching for history information of the application and providing the call connection information to a terminal associated with the history information.

11. The method of claim 8, wherein, when the second terminal is not found by the searcher, the generating and providing comprises providing the call connection information to a terminal number that is authenticated.

12. The method of claim 8, further comprising providing, by a message provider, a first message indicating that the call connection information is transmitted to the second terminal to the webpage of the first terminal.

13. The method of claim 8, further comprising comparing, by a calling route information provider, first call information related to the first and second terminals according to a selection signal of the phone number link object displayed on the webpage of the first terminal and second call information related to a call signal from the third terminal driven according to the selection signal, and displaying, by the calling route information provider, some of the first call information on the third terminal according to a matching determination result of the selection signal and the call signal.

14. The method of claim 8, wherein the first and second terminals are a same terminal.

15. A non-transitory computer-readable recording medium having recorded thereon a program for providing call connection information, the program when executed by a computer, performs the method comprising:
receiving a phone number link object signal enabling a call connection with a third terminal selected by a user from a webpage on a first terminal, which is authenticated by using access identification (ID) information;
searching for a second terminal that is authenticated by using the access ID information and activated by using an application corresponding to the webpage on the first terminal; and
generating and providing call connection information comprising a phone number link object to the second terminal.
